(19) United States
(12) Patent Application Publication
(10) Pub. No.: US 2023/0270065 A1
(43) Pub. Date: Aug. 31, 2023

(54) SYSTEMS AND METHODS FOR THE HATCHING, SEEDING, AND/OR CULTIVATING OF A TARGET PRODUCT

(71) Applicant: Running Tide Technologies, Inc., Portland, ME (US)

(72) Inventors: Samuel WOOLF, Brunswick, ME (US); Sean Arthur FOORMAN, Denver, CO (US); Matthew Jordan ODLIN, Freeport, ME (US)

(21) Appl. No.: 18/134,290

(22) Filed: Apr. 13, 2023

Related U.S. Application Data
(63) Continuation of application No. PCT/US2021/054952, filed on Oct. 14, 2021.
(60) Provisional application No. 63/091,753, filed on Oct. 14, 2020.

(51) Int. Cl. A01G 33/00; A01G 9/24

(52) U.S. Cl. CPC A01G 33/00; A01G 9/249; A01G 9/247

(57) ABSTRACT

An apparatus includes a shipping container, an electrical interface configured to electrically couple the shipping container to an electrical power source, and a water interface configured to fluidically couple the shipping container to a water source. The shipping container has disposed therein one or more cultivation chamber, a water circulation system in fluid communication with the cultivation chamber(s), a gas circulation system in fluid communication with the cultivation chamber(s), and a light system. Each cultivation chamber is configured to receive at least one biological component of a target product. The water circulation system is configured to provide a volume of water into the cultivation chamber(s), the gas circulation system is configured to provide a flow of gas into the cultivation chamber(s), and the light system is configured to provide light to the cultivation chamber(s).

### CROSS-REFERENCE TO RELATED APPLICATIONS

This application claims priority to and the benefit of U.S. Provisional Patent Application Ser. No. 63/091,753, filed Oct. 14, 2021, entitled “Systems and Method for the Seeding, Cultivation, and/or Harvesting of Macroalgae,” the disclosure of which is incorporated herein by reference in its entirety.

### BACKGROUND

This disclosure relates generally to systems and methods for hatching, cultivating, seeding, and/or deploying target products, and more particularly, to offshore and/or mobile hatcheries for hatching, cultivating, seeding, and/or deploying target products such as macroalgae and/or the like.

Cultivating and/or accumulating aquatic and/or marine species or mass has gained significant interest in received years. Species of algae (e.g., microalgae, macroalgae, etc.), crustaceans, plankton, and/or filter feeders can be used for food or feed, as food processing additives, as packaging materials, as fertilizers, and/or as raw materials for biofuels, cosmetics, pharmaceutical products, and/or other (bio) materials, etc. Aquatic and/or marine mass also can be used for bioremediation, carbon capture, and/or toward other suitable ends. Cultivating and/or accumulating marine mass has many advantages. Compared to the cultivation of plants on land, the cultivation of marine species leads to higher productivity. In addition, no scarce farmland or freshwater is needed, and no additional nutrients are needed for ocean-based cultivation. Furthermore, targeted cultivation of marine species can contribute to protecting or increasing marine biodiversity and/or to mitigating harmful effects of anthropogenic greenhouse gas emissions. (e.g., carbon dioxide and/or the like).

Current processes of growing and/or cultivating marine species such as macroalgae generally begin at onshore hatchery facilities, and/or the like. For example, some know methods of hatching and/or seeding macroalgae including collecting sori, which contain asexual zoospores, from spawning macroalgae either in the wild or farmed. At the hatching facility, the zoospores are held in a bath and selectively allowed to develop (e.g., using desired—red or blue—lighting conditions) into gametophytes having male reproductive structures (with antheridia) or female reproductive structures (with oogonia), which then develop into sporophytes after fertilization. In some instances, the sporophytes can then be transferred into a bath containing a seeding line (or one or more reels of seeding line) and/or the like to which the sporophytes attach. In other instances, the seeding line (or one or more reels thereof) can be contained in the initial bath prior to the addition and/or introduction of the zoospores (e.g., known as a “direct seeding” method). After a desired amount of development, the seeding lines (or one or more reels thereof) are transferred from the onshore hatchery to a vessel which carries the seeding lines (or one or more reels thereof) to an offshore deployment site, where the seeding lines are attached to longlines, ropes, header lines, culture lines, etc. Such known hatching and/or seeding methods, however, are labor intensive, inefficient, and/or expensive. Moreover, offshore deployment sites may be in remote and/or distant locations requiring a vessel to haul seeded cultivation equipment, which can be an inefficient use of space or resources and/or can lead to improper storage, handling, and/or treatment of the developing species.

Accordingly, a need exists for improved systems and methods for hatching and/or seeding target products, delivering the developing target products to desired deployment locations, transferring or attaching the seeded target products to cultivation apparatuses and/or microfarms, and/or deploying the cultivation apparatuses and/or microfarms.

### SUMMARY

Described herein are systems and methods for hatching, cultivating, seeding, etc. a target product. In some embodiments, an apparatus includes a shipping container, an electrical interface configured to electrically couple the shipping container to an electrical power source, and a water interface configured to fluidically couple the shipping container to a water source. The shipping container has disposed therein one or more cultivation chamber, a water circulation system in fluid communication with the cultivation chamber(s), a gas circulation system in fluid communication with the cultivation chamber(s), and a light system. Each cultivation chamber is configured to receive at least one biological component of a target product (e.g., sori, zoospores, gametophytes, and/or sporophytes). The water circulation system is configured to provide a volume of water into the cultivation chamber(s), the gas circulation system is configured to provide a flow of gas into the cultivation chamber(s), and the light system is configured to provide light to the cultivation chamber(s).

### BRIEF DESCRIPTION OF THE DRAWINGS

FIG. 1 is a schematic illustration of a cultivation apparatus according to an embodiment.

FIG. 2 is a schematic illustration of an offshore and/or mobile hatchery for hatching, seeding, and/or cultivating target products and/or biological components thereof, according to an embodiment.

FIG. 3 is a flowchart illustrating a method of establishing, assembling, and/or using an offshore and/or mobile hatchery according to an embodiment.

FIG. 4 is a flowchart illustrating a method of using an offshore and/or mobile hatchery according to an embodiment.

### DETAILED DESCRIPTION

Systems and methods for the offshore and/or mobile hatching of a target product are described herein. In some implementations, the systems and methods described herein can provide an offshore and/or mobile hatchery that can be used to hatch and/or populate a target product or biological component(s) of the target product such as but not limited to certain species of macroalgae and/or biological components thereof (e.g., sori, zoospores, gametophytes and/or sporophytes). Any of the offshore and/or mobile hatcheries described herein can also be used to seed and/or attach the target product or biological component of the target product to one or more cultivation apparatus, microfarms, and/or deployment structures. With the target product or biological component of the target product seeded and/or attached, the cultivation apparatus, microfarms, and/or deployment structures can be deployed in a body of water (e.g., oceans, seas, lakes, rivers, and/or the like) and/or can be delivered to a vessel or the like from which the cultivation apparatus, microfarms, and/or deployment structures can be deployed.

In general, target products such as macroalgae or the like become positively or negatively buoyant as they mature, allowing the deployed target product to be harvested and/or sequestered. Interest in large-scale (e.g., on the order of multi-gigatons) sequestration of the biomass of target products continues to increase as technologies are developed for the abatement of harmful anthropogenic greenhouse gas emissions such as, for example, carbon sequestration. Target products such as macroalgae have shown promise as a carbon sequestration technology as an estimated 11% of its biomass is naturally sequestered to the seafloor. Macroalgae cultivation has the potential to improve this sequestration rate significantly due to increased cultivation productivity relative to naturally-occurring macroalgae. In some implementations, carbon sequestered per unit of macroalgae that sinks to the seafloor can be quantified, calculated, and/or valued and a credit tied to and/or otherwise associated with the calculated capacity of the macroalgae to sequester that carbon can be sold in a carbon credit market (or any other suitable market). As prices in the global carbon credit market continue to climb, it remains desirable to improve and/or develop new devices and/or methods for hatching, developing, cultivating, and/or sinking target products.

In some embodiments, an apparatus includes a shipping container, an electrical interface configured to electrically couple the shipping container to an electrical power source, and a water interface configured to fluidically couple the shipping container to a water source. The shipping container has disposed therein one or more cultivation chamber, a water circulation system in fluid communication with the cultivation chamber(s), a gas circulation system in fluid communication with the cultivation chamber(s), and a light system. Each cultivation chamber is configured to receive at least one biological component of a target product (e.g., sori, zoospores, gametophytes, and/or sporophytes). The water circulation system is configured to provide a volume of water into the cultivation chamber(s) (and/or a flow of water for continuous or periodic media changes), the gas circulation system is configured to provide a flow of gas (e.g., air) into the cultivation chamber(s), and the light system is configured to provide light to the cultivation chamber(s).

In some implementations, a method includes assembling, at an assembly location, a macroalgae hatchery within a shipping container. The macroalgae hatchery including an electrical and a water interface, each of which is coupled to an outer surface of the shipping container. The macroalgae hatchery is transported to a deployment location that is different from the assembly location. At the deployment location, the electrical interface is electrically coupled to an electrical power source and the water interface if fluidically coupled to a water source.

In some implementations, a method includes electrically coupling to an electrical power source an electrical interface of a macroalgae hatchery housed within a shipping container to an electrical power source. A water interface of the macroalgae hatchery is fluidically coupled to a water source. The electrical interface and the water interface are coupled to an outer surface of the shipping container. A volume of water is transferred through a water circulation system of the macroalgae hatchery to at least one cultivation chamber. The water circulation system and the at least one cultivation chamber being disposed within the shipping container. A flow of gas is transferred through a gas circulation system to the at least one cultivation chamber. The gas circulation system is disposed within the shipping container. A flow of electric power is provided to a light system disposed within the shipping container such that the light system provides light to at least one biological component of macroalgae (e.g., sori, zoospores, gametophytes, or sporophytes) contained in the at least one cultivation chamber.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

Embodiments described herein relate to devices, systems, and methods that aid, foster, and/or facilitate the hatching, seeding, early development, and/or cultivation of target product(s). As used herein, “target product” generally refers to one or more aquatic and/or marine species of interest. For example, a “target product” can include but is not limited to aquatic and/or marine species such as crustaceans, plankton, filter feeders, heterokonts like algae(s) (microalgae, macroalgae, etc.), and/or the like. In other implementations, however, a target product can refer to any suitable species whose cultivation leads to a desired result (e.g., as a harvested product, for bioremediation, for carbon capture and sequestration, and/or the like).

As used herein, a “biological component” of a target product generally refers to one or more components of the target product associated with a phase of target product development. For example, a target product can be, for example, mature or maturing macroalgae, while a biological component of the macroalgae can be sori, zoospores, gametophytes, sporophytes, and/or the like. Thus, while the biological components develop into the target product, the biological components themselves, may or may not be considered the target product or the whole of the target product. In general, the biological components of a target product are, for example, the early developmental biological components cultivated in, for example, a hatchery, while the target product as a whole is, for example, seeded on and/or cultivated on or by a cultivation apparatus and/or portions thereof.

The target products described herein are select marine species who's natural and/or desired habitat is a body of water. When referring to a body of water, it should be understood that the body of water can be selected based on characteristics that may facilitate the cultivation of the target product. Accordingly, though specific bodies of water may be referred to herein (e.g., an ocean or sea), it should be understood that the embodiment, example, and/or implementation so described is not limited to use in such an environment unless the context clearly states otherwise. Moreover, the term “saltwater” as used in this specification and the appended claims is intended to refer to any body of water, the constituents of which include a certain concentration of salt(s). In contrast “freshwater” can refer to any body of water, the constituents of which do not include or include limited concentrations of salt(s). Saltwater, for example, can refer to the water forming oceans, seas, bays, gulfs, etc. Freshwater, for example, can refer to the water forming rivers, lakes, etc. Moreover, certain mixtures of freshwater and saltwater are generally known as “brackish” (e.g., the mixture of river water and sea water found in estuaries and/or the like).

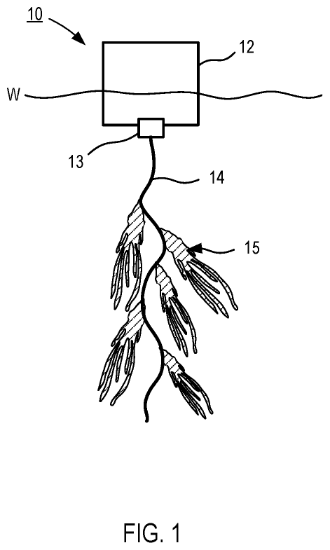

Referring now to the drawings, FIG. 1 is a schematic illustration of a cultivation apparatus 10 according to an embodiment. In some implementations, the cultivation apparatus 10 can be used to cultivate one or more target products such as, for example, one or more macroalgae species and/or the like. In some implementations, the cultivation apparatus 10 can be included in a deployment of any number of cultivation apparatus. For example, in some implementations, a deployment can include tens, hundreds, thousands, tens of thousands, hundreds of thousands, or more cultivation apparatus 10, each of which has been seeded with and/or has attached thereto, one or more target products. As described in further detail herein, a deployment of cultivation apparatus 10 can be in any suitable geographical location on any suitable body of water. In some instances, for example, an ocean deployment can be relatively far offshore and/or in relatively remote locations. In such instances, the use of a typical onshore hatchery station or facility and/or the transportation to such locations of a large number of cultivation apparatus 10 seeded at such a facility may be infeasible and/or impracticable. Therefore, such instances, give rise to a need for offshore and/or mobile hatcheries such as those described herein.

A discussion of the cultivation apparatus 10 shown in FIG. 1 is provided below for context. A discussion of embodiments, aspects, features, and/or methods of one or more offshore and/or mobile hatcheries for a target product follows the discussion of the cultivation apparatus 10.

The cultivation apparatus 10 includes a first member 12, a second member 14, and an intermediate member 13 configured to reversibly couple the first member 12 to the second member 14. The cultivation apparatus 10 and/or the first, second, and intermediate members thereof, can be any suitable shape, size, and/or configuration. In some embodiments, for example, the cultivation apparatus 10 can be similar to and/or substantially the same as any of the cultivation apparatus (also referred to as “microfarms”) described in detail in U.S. patent application Ser. No. 17/342,143, filed Jun. 8, 2021, entitled “Systems and Methods for the Cultivation of Target Product,” the disclosure of which is incorporated herein by reference in its entirety (referred to herein as the “'143 application”).

In some embodiments, the cultivation apparatus 10 can be arranged in a modular configuration in which one or more portions of the first member 12, the second member 14, and/or the intermediate member 13 can be mechanically coupled to collectively form the cultivation apparatus 10. For example, in some implementations, an end user can at least temporarily couple the first member 12, the second member 14, and the intermediate member 13 at a hatchery such as an offshore or mobile hatchery such as those detail herein. In other implementations, a second member 14 can be seeded with a target product (or a target product can be attached to the second member 14) at an offshore or mobile hatchery such as those described herein and loaded onto a deployment vessel or the like. In such implementations, the cultivation apparatus 10 can be assembled (e.g., the first member 12, the second member 14, and the intermediate member 13 can be temporarily coupled) on the vessel when the vessel approaches and/or is at a desired deployment location. In some embodiments, the cultivation apparatus 10 need not be modular. For example, the cultivation apparatus 10 can be pre-coupled during manufacturing and/or prior to being delivered to an end user.

The first member 12 of the cultivation apparatus 10 can be any suitable shape, size, and/or configuration. In some embodiments, the first member 12 can be similar to and/or substantially the same as any of the first members of the cultivation apparatuses described in the '143 application. For example, in some implementations, the first member 12 of the cultivation apparatus 10 can include and/or can form a growth substrate or the like configured to be seeded with and/or otherwise receive a target product such as one or more species of macroalgae gametophytes and/or sporophytes. In some embodiments, one or more portions of the first member 12 can be formed of a relatively buoyant material and/or can be seeded with and/or attached to a target product that is or that becomes positively buoyant as the target product matures, thereby allowing the first member 12 to float on a surface of the water W. In some instances, such an arrangement can allow at least the first member 12 to be retrieved and/or the target product to be harvested after a predetermined time and/or after a desired amount of target product growth or accumulation.

In some embodiments, the first member 12 can be configured to provide buoyancy to the various components of the cultivation apparatus 10 without being seeded with and/or otherwise attached to a target product (e.g., a positively buoyant target product). For example, in some implementations, the first member 12 can be a flotation device or buoy such as a navigation buoy, a mooring buoy, a shot buoy, a spar buoy, and the like. In some embodiments, such a first member 12 can include or can be coupled to any number of devices, sensors, radios, cameras, and/or the like configured to capture, collect, and/or determine any suitable data associated with the cultivation apparatus 10 and/or target product growth or accumulation. As such, the buoyant first member 12, and the devices, etc. included therein or coupled thereto, can be retrieved, for example, after a threshold time, after a desired amount of target product growth, and/or in response to any other criterion(ia) being satisfied).

In some embodiments, the first member 12 can be selectively buoyant or only temporarily buoyant regardless of whether the first member 12 is seeded with or attached to a target product. For example, the first member 12 can be and/or can include an inflatable bladder, vesicle, and/or can otherwise be formed of a material that can at least temporarily contain air and/or other gases (pressurized or at atmospheric pressure). In some embodiments, the first member 12 (e.g., in the form of or including a bladder) can include a mechanical, chemical, and/or biological timer/valve configured to release gas contained therein after a predetermined time (e.g., a time associated with and/or allowing for a desired amount of target product growth and/or accumulation), thereby reducing the buoyancy of the first member 12. In some embodiments, the first member 12 or at least a portion thereof can be configured to partially or completely degrade and/or decompose after a threshold period of being deployed (e.g., in or on an ocean, etc.) and/or in response to or after the cultivation apparatus 10 sinking to the sea/ocean bottom. In some embodiments, the first member 12 can include one or more portions that can degrade and/or decompose at different rates and/or at variable rates in response to environmental conditions. In some embodiments, the first member 12 can include a sealing member at least temporarily coupled to and/or at least temporarily disposed in the first member 12. In some implementations, the sealing member can be degradable and/or automatically or manually can be decoupled from the first member 12, thereby allowing the air and/or other gases contained therein to escape. As such, the first member 12 (and thus, the cultivation apparatus 10) can be positively buoyant when initially deployed, allowed to float for a predetermined and/or threshold time after being deployed, and then allowed to sink as a target product seeded on or attached to the cultivation apparatus 10 grows and obtains biomass, as described in detail in the '143 application.

The second member 14 of the cultivation apparatus 10 can be any suitable shape, size, and/or configuration. In some embodiments, the second member 14 can be similar to and/or substantially the same as any of the second members of the cultivation apparatuses described in the '143 application. For example, in some embodiments, the second member 14 can be similar to or substantially the same as the first member 12. In some embodiments, the second member 14 can be one or more seeding lines, long lines, ropes, and/or the like. In some embodiments, the second member 14 can include optional weight(s) such as metallic rings and/or the like (not shown) to provide negative buoyancy of and/or associated with the second member 14.

In some implementations, the second member 14 can be configured to receive one or more species of a target product 15 such as one or more species of macroalgae gametophytes and/or sporophytes. For example, one or more portions and/or surfaces of the second member 14 can be formed of and/or can include a growth substrate (not shown) configured to provide nutrients facilitating growth of the target product 15, a binder configured to facilitate attachment of the gametophytes and/or sporophytes, and/or one or more additives formulated to suppress contamination of the gametophytes and/or sporophytes. For example, in some embodiments, the second member 14 can include, can be formed of, can be saturated or impregnated with, etc. a growth substrate material such as, for example, an enriched seawater medium, pasteurized seawater, filtrated seawater, seawater mixed with buffer solutions including but not limited to sodium nitrate (NaNO3) solution, potassium dihydrogen phosphate (KH2PO4) solution, germanium dioxide (GeO2), and/or the like.

As described in further detail herein, in some implementations, the second member 14 can be seeded with a target product (e.g., macroalgae gametophytes and/or sporophytes) at, for example, an offshore and/or mobile hatchery such as those described herein. In some implementations, the second member 14 can be coupled to the first member 12 and/or the intermediate member 13 at the hatchery. In other implementations, the second member 14 can be seeded with the target product at the hatchery and loaded onto a vessel for transportation to a desired deployment location. In such implementations, the first member 12, the second member 14, and the intermediate member 13 can be coupled to collectively form the cultivation apparatus 10. In some instances, the assembly of and/or coupling to form the cultivation apparatus 10 can be performed on the vessel, for example, in an on-demand manner when at the desired deployment location.

The intermediate member 13 of the cultivation apparatus 10 can be any suitable shape, size, and/or configuration. In some embodiments, the intermediate member 13 can be similar to and/or substantially the same as any of the intermediate members of the cultivation apparatuses described in the '143 application. For example, in some embodiments, the intermediate member 13 can be similar, at least in part, to the first member 12 and/or second member 14. The intermediate member 13 is configured to couple at least temporarily the first member 12 to the second member 14. For example, one or more portions of the intermediate member 13 can be and/or can include an adhesive, glue, paste, cement, etc.; one or more mechanical linkages such as ring(s), shackle(s), swivel(s), joint(s), and/or the like; one or more anchor points such as tie knot(s), thimble kit(s), hook(s), and/or the like; and/or any other suitable coupling.

In some embodiments, the intermediate member 13 can be formed of a degradable material, a compostable co-polyester, a cellulose-based material, and/or the like. For example, the intermediate member 13 can be formed of and/or can include polyglycolide, polylactide, polyhydroxobutyrate, chitosan, hyaluronic acid, poly(lactic-co-glycolic), poly (caprolactone), polyhydroxyalkanoate, Ecoflex®, Ecovio®, and/or any other ocean compatible material(s) and/or combinations thereof. While examples of degradable and/or compostable materials are listed, it should be understood that other materials are possible, and the materials are not intended to be limited to those stated.

As described above with reference to the first member 12, the intermediate member 13 can be configured to degrade after a threshold or predetermined time of being deployed. In some implementations, the degrading of the intermediate member 13 can allow and/or can result in a decoupling of the first member 12 from the second member 14. In some embodiments, the intermediate member 13 can be configured to degrade after a desired amount of growth or accumulation of the target product 15 attached to at least the second member 14. In some embodiments, the intermediate member 13 can be configured to degrade under predetermined environmental conditions including but not limited to temperature, pressure, exposure to UV and/or visible light, and/or the like. As described above, in some implementations, the first member 12 can be positively buoyant and/or a target product attached to the first member 12 can be positively buoyant, while the second member 14 can be negatively buoyant and/or the target product 15 attached to the second member 14 can be negatively buoyant. Thus, when the intermediate member 13 decouples the first member 12 from the second member 14 (e.g., as a result of degrading or as a result of a mechanical decoupling), the first member 12 can float at or on a surface of the ocean, while the second member 14 and the target product 15 attached thereto can sink to the bottom or floor of the body of water (e.g., seafloor, ocean floor, etc.). The sinking of the second member 14 and the target product 15 attached thereto effectively sequesters an amount of carbon associated with and/or captured by the target product 15. In some embodiments, the floating first member 12 facilitates harvesting operations of, for example, a positively buoyant target product attached to the first member 12 and/or can otherwise allow the first member 12 to be retrieved and reused. In other embodiments, the first member 12 can be configured to degrade and/or otherwise decompose on the surface of the water or can be configured to degrade and sink to the bottom or floor of the body of water (e.g., in implementations when no target product is attached to the first member 12).

In some embodiments, the cultivation apparatus 10 and/or one or more components thereof (e.g., the first member 12) can include and/or can be coupled to device(s) configured to sense, detect, and/or monitor growth of the target product 15, biomass generation, biomass yield, environmental characteristics or data, and/or any other data associated with a deployment of one or more cultivation apparatus. For example, in some embodiments the cultivation apparatus 10 can include one or more sensors, cameras (e.g., underwater cameras and/or other imaging technologies), tracking devices (e.g., a Global Positioning System (GPS) tracking device, a Radio-Frequency Identification (RFID) device, and/or the like), and/or any other suitable device. In some embodiments, the cultivation apparatus 10 can include any of the sensors, imaging devices, tracking devices, and/or remote sensing techniques described in detail in '143 application. Moreover, in some implementations, including such device in or coupling such devices to the first member 12 can allow the retrieval of the first member 12 and devices after, for example, the second member 14 has been decoupled from the first member 12. As such, data associated with and/or collected at or by the cultivation apparatus 10 can be aggregated, analyzed, calculated, processed, etc. to allow for a determination, estimation, and/or prediction of, for example, historical or current target product growth or growth rates, biomass production, biomass yield, sinking rate(s), location(s) of a deployment, dispersion of a deployment, environmental conditions in an area corresponding to a deployment, and/or any other desired information associated with the cultivation apparatus 10 and/or a deployment of any number of cultivation apparatus. Moreover, in some implementations, such information can be used and/or can otherwise inform one or more predictions and/or quantifications associated with carbon capture and/or sequestration rates, quantities, capacities, and/or the like, as described in detail in the '143 application.

In some instances, such calculations, derivations, correlations, analyses, and/or the like can lead to and/or produce a desired level of predictability, foreseeability, and/or the like. The ability to predict and/or forecast growth and/or performance characteristics of the apparatus 10 (and/or a farm including large numbers of the apparatus 10) and/or a capacity to sequester carbon or carbon dioxide can, for example, enable the capacity to be bought and/or sold as a commodity and/or the like. For example, determining a sequestration capacity per unit mass and/or length of macroalgae can allow that capacity to be sold as a carbon credit on a carbon credit market. In some instances, the macroalgae and/or the carbon sequestration capacity can be bought and sold, for example, on a commodities market, a futures market, and/or any other suitable market, as described in detail in the '143 application.

As described above, the cultivation apparatus 10 described above is seeded with one or more species of a target product such as macroalgae, and then is deployed in a body of water such as an ocean, sea, etc. In some instances, the hatching and seeding of the cultivation apparatus 10 can be performed using known systems and/or methods at an onshore hatchery facility and/or the like. In some such instances, the seeding lines can be spooled (if not already in a spooled or reeled configuration) and transferred from the onshore hatchery onto a vessel where the spools are attached to any of the cultivation apparatus described herein. In other instances, the spools and/or seeding lines can be attached to any of the cultivation apparatus described herein at the onshore hatchery and/or otherwise onshore or in relative proximity to the shore. Once attached, a vessel can be used to tow the one or more of the seeded cultivation apparatus to a desired deployment location. In still other instances, the seeded cultivation apparatus can be deployed directly from the shore, directly from the onshore hatchery, and/or the like.

In some implementations, such an onshore hatchery and/or onshore deployment site can include a discharging mechanism or the like that can be configured to discharge, release, and/or otherwise deploy the seeded cultivation apparatus at a desired distance from the shore and/or otherwise at a location having desirable offshore currents. Such a discharging mechanism can be, for example, a submerged tunnel, tube, conduit, channel, etc. In some implementations, a flow of water can pass through and/or along the discharging mechanism to facilitate movement of the cultivation apparatus through the discharging mechanism. For example, a pump can be used to facilitate a flow of water through the discharging mechanism. In some implementations, the flow of water and the movement of the cultivation apparatus through the discharging mechanism can be controlled, monitored, limited, modulated, etc. to limit and/or substantially prevent damage to the macroalgae resulting from undesirably high flow rates, pressures, and/or turbulence. Traditional onshore hatchery facilities, however, may not be suitable for remote deployment locations and/or in areas with limited resources, access, and/or the like.

Accordingly, in some implementations, hatching and/or seeding of the target product or biological components of the target product can be performed, for example, at an offshore hatchery and/or in or at a mobile hatchery such as those described herein. In some implementations, for example, a hatchery can be assembled and/or housed within a shipping container, while an exterior of the shipping container remains within predefined specifications for shipping and/or transporting via marine vessels, trains, cargo planes, and/or other cargo carriers, etc. In some implementations, such a hatchery can be used on a relatively large vessel, ship, boat, etc., capable of remaining at sea for a relatively extended period of time. In such implementations, using the hatchery on the ship or vessel can result in longer vessel deployment times by reducing an amount that the ship or vessel would otherwise return to port to collect a new batch of seeded lines from a traditional onshore hatchery. In other implementations, such a hatchery can be assembled at an assembly location and transported or shipped (e.g., via a marine vessel, train, plane, etc.) to a deployment or operating location, which in some instances, can be in relatively remote locations and/or in locations with limited resources and/or access. As such, a self-contained, mobile hatchery can allow for the hatching and/or seeding of the target product or biological components of the target product in areas where the use of traditional onshore hatchery facilities may be infeasible, expensive, and/or impracticable, though the use of the mobile hatcheries described herein is not limited to such implementations.

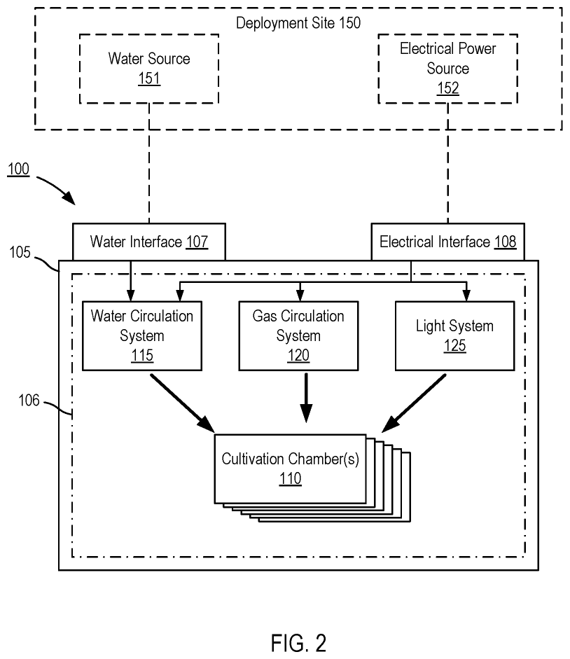

FIG. 2 is a schematic illustration of an offshore and/or mobile hatchery 100 (referred to herein as “hatchery”) according to an embodiment. As described above, the hatchery 100 can be a structure, facility, laboratory, system, and/or assembly of components configured to aid, foster, and/or facilitate the hatching and/or early development of target product(s) (or biological component(s) thereof) such as but not limited to certain species of macroalgae and/or macroalgae sori, zoospores, gametophytes, and/or sporophytes. The hatchery 100 can also be used to and/or can otherwise allow for the seeding and/or attachment of the target product(s) to one or more cultivation apparatus, microfarms, and/or deployment structures (e.g., the cultivation apparatus 10 described above with reference to FIG. 1). With the target product or the biological component(s) of the target product seeded and/or attached, the cultivation apparatus, microfarms, and/or deployment structures can be deployed in a body of water (e.g., oceans, seas, lakes, rivers, and/or the like) and/or can be delivered to a vessel or the like from which the cultivation apparatus, microfarms, and/or deployment structures can be deployed.

The hatchery 100 can be any suitable shape size and/or configuration. For example, the hatchery 100 can be a relatively compact, mobile, and/or modular unit that can be transported to any suitable deployment location via traditional transportation and/or shipping modes. For example, the hatchery 100 can be disposed, assembled, and/or implemented in, for example, a standard intermodal container 105 (e.g., a rigid shipping container and/or the like). The intermodal container 105 (also referred to herein as “shipping container” or “container”) can be an ISO standard container and/or a North American standard container. In general, the shipping container 105 is a rectangularly-shaped, steel enclosure commonly used for dry storage, bulk storage, etc. Standard sizes for ISO standard containers are, for example, a length of 20 feet (ft) (6.058 meters (m)), 40 ft (12.192 m), or 45 ft (13.716 m); a height of 8.5 ft (2.591 m) or 9.5 ft (2.896 m); and a width of 8 ft (2.438 m). Standard and/or common sizes for North American shipping containers are a length of 40 ft (6.058 m), 48 ft (14.630 m), or 53 ft (16.154 m); a height of 8.5 ft (2.591 m) or 9.5 ft (2.896 m); and a width of 8 ft (2.438 m) or 8.5 ft (2.591 m). The hatcheries described herein (e.g., the hatchery 100) can be implemented in any of the standard and/or common sized containers. For example, the shipping container 105 can have a length of 40 ft (12.192 m), a width of 8 ft (2.438 m), and height of 8.5 ft (2.591 m).

In some implementations, the container 105 includes a set of doors on one end thereof allowing for ingress and egress. In some implementations, the container 105 can include additional openings, doors, and/or accesses. The container 105 can be completely enclosed (when the doors are closed) or can include, for example, a removable and/or retractable portion allowing the container 105 to be open on at least one side (e.g., a removable top portion or the like). The structure forming the container 105 (e.g., the walls, doors, floor, roof, etc.) can be formed of or from steel or can include one or more portions from of or from any other suitable material. For example, in some embodiments, the container 105 can include a top or roof (or a portion thereof) formed of a relatively transparent material allowing sunlight to enter the container 105. In any embodiment, the arrangement of the container 105 is such that the container complies with predetermined standards for intermodal containers allowing the container 105 to be transported and/or shipped (e.g., to a deployment location) using known transportation modes such as truck, rail, ship (transoceanic vessels), and/or air.

As shown in FIG. 2, an interior volume of the container 105 includes thermal insulation 106 allowing for temperature control within at least a portion of the container 105. The insulation 106 can be, for example, foam board insulation, spray foam insulation, and/or any other suitable insulation or combinations thereof. In some implementations, the container 105 can include one or more partitions (not shown) that can, for example, divide the hatchery 100 into two or more workspaces. For example, the container 105 can include a partition that forms, for example, a first workspace and a second workspace. The partition can be an insulated partition or a wall built and attached to an interior of the container 105 to limit heat transfer between workspaces while having a door allowing access therebetween. In addition to forming a thermal barrier, the partition can also form a liquid barrier that limits and/or substantially prevents liquid (e.g., water) from flowing between the workspaces. In such embodiments, the first workspace and the second workspace can be used for different purposes and can include different insulation 106 based at least in part on a desired use of the workspace. For example, the first workspace can be a refrigerated and/or otherwise temperature controlled environment suitable for hatching, growing, and/or allowing the development of a target product, while the second workspace is not refrigerated or is heated (e.g., when the hatchery 100 is deployed and/or used in relatively cold environments). Accordingly, the insulation 106 in the first workspace can be selected to limit heat transfer into the first workspace from the second workspace and/or from the environment outside the container 105.

As shown in FIG. 2, the hatchery 100 includes at least a set of cultivation chambers 110, a water circulation system 110, a gas circulation system 115, and a light system 120. The hatchery 100 and/or the container 105 also includes a water interface 107 and an electrical interface 108 that allow the hatchery 100 to be connected to a water source 151 and an electrical source 152 at a deployment site 150. Although not shown in FIG. 2, the hatchery 100 can further include any suitable workbenches, tables, desks, sinks, tubs, and/or any other suitable structure. In some implementations, such components and/or structures can be known components and/or components having a relatively common form and/or function. Accordingly, such components and/or structures are not described in further detail herein.

In some implementations, the hatchery 100 can be assembled and/or built at an assembly location and used, for example, at a separate deployment site. In some implementations, having the hatchery 100 in a shipping container 105 can allow the hatchery 100 to be transported and/or shipped to the deployment site 150 using known transportation and/or shipping modalities such as truck, rail, oceanic ship, and/or air. The deployment site 150 can be any suitable site that can accommodate, for example, the container 105 (e.g., a structure that is at least 40 ft×8 ft). In some instances, the deployment site 150 can be a relatively remote land-based location. In some instances, the deployment site 150 can be an offshore platform or support structure (e.g., in an ocean or other body of water). In some instances, the deployment site 150 can be a vessel such as a cargo ship or vessel (e.g., a transoceanic container ship) and/or any other suitable vessel. In some implementations, providing the offshore and/or mobile hatchery 100 to the deployment site 150 can allow for on-demand and/or on-location use, which can be more efficient, less expensive, and/or less likely to result in harm to the target products than known processes of loading seeded cultivation apparatus onto a vessel for delivery to a deployment location in a body of water. Moreover, assembling the hatchery 100 within the container 105 can provide a relatively efficient and scalable way of providing hatcheries to any deployment site as needed.

In some implementations, the deployment site 150 can be any suitable site that can provide and/or allow access to the water source 151 and the electrical power source 152. In some implementations, the water source 151 can be, for example, a saltwater source such as an ocean, sea, etc. For example, the deployment site 150 can be a vessel, an offshore platform or support structure, a land-based location relatively close to a shore, and/or the like. In such implementations, the deployment site 150 can provide access to a flow or source of saltwater. In other implementations, the water source 151 can be, for example, a freshwater source such as municipal water, well water, lake water, river water, and/or the like. In some implementations, the deployment site 150 can include, for example, a first water source that provides freshwater and a second water source that provides saltwater.

The water interface 107 of the hatchery 100 and/or container 105 can be any suitable shape, size, and/or configuration. In some embodiments, the water interface 107 or at least a portion thereof can be any suitable connector, adapter, interface, etc. coupled to an outer surface of the container 105. The water interface 107 is configured to be fluidically coupled to and/or otherwise placed in fluid communication with the water source 151 at the deployment site 150 to provide a flow of water to the hatchery 100 disposed in the container 105. In this context, the terms “fluidically coupled” and “fluid communication” are intended to refer to any suitable direct or indirect connection, coupling, and/or mode of conveyance that allows a flow of fluid (e.g., freshwater, saltwater, etc.) from the water source 151 to the water interface 107. In this manner, any number and/or type(s) of devices, pumps, storage tanks, plumbing, etc. can be disposed between the literal water source 151 (e.g., the ocean) and the water interface 107 to establish “fluid communication” therebetween and/or to “fluidically couple” the water interface 107 to the water source 151. In a similar manner, the water circulation system 110 of the hatchery 100 is fluidically coupled to and/or in fluid communication with the water interface 107 via any intervening manifold, plumbing, pump, reservoir, holding tank, filter, etc.

The electrical power source 152 can be any suitable power source. For example, in some implementations, the electrical power source 152 can be, for example, the grid and/or any suitable electrical utility provided by the deployment site 150 (e.g., as part of the utility and/or electrical infrastructure of and/or at the deployment site 150. In other implementations, the electrical power source 152 can be any suitable self-contained or off-grid power source such as solar panels, wind-powered generator, hydro-dynamic power source, and/or the like. In such implementations, the self-contained or off-grid power source can be installed and/or otherwise used at the deployment site 150 whether as a part of the utility and/or electrical infrastructure of and/or at the deployment site or can be independent of the utility and/or electrical infrastructure. For example, in some implementations, the electrical power source 152 can be a solar-powered electrical system that is included in, on, and/or otherwise provided by or with the hatchery 100 that is physically installed and used at a deployment site 150. In other implementations, the electrical power source 152 can be any suitable electrical power generator and/or storage system.

The electrical interface 108 of the hatchery 100 and/or container 105 can be any suitable shape, size, and/or configuration. In some embodiments, the electrical interface 108 or at least a portion thereof can be any suitable connector, adapter, interface, etc. coupled to an outer surface of the container 105. The electrical interface 108 is configured to be electrically coupled and/or connected to and/or otherwise placed in electric communication with the electrical power source 152 at the deployment site to provide a flow of electric power to the hatchery 100 disposed in the container 105. In this context, the terms “electrically coupled,” “electrically connected,” and “electric communication” are intended to refer to any suitable direct or indirect connection, coupling, and/or mode of conveyance that allows a flow of electric power or current from the electrical power source 152 to the electrical interface 108. The electrical interface 108 may be adaptable to a variety of international voltage and/or current standards. Any number and/or type(s) of transformers, converters, storage devices (batteries), cables, etc. can be disposed between the literal electrical power source 152 (e.g., a solar panel or battery storage) and the electrical interface 108 to establish “electric communication” therebetween and/or to “electrically couple” or “electrically connect” the electrical interface 108 to the electrical power source 152.

Although not shown in FIG. 2, the electrical interface 108 and/or the hatchery 100 can include any suitable transformer and/or distribution panel configured to condition, transform, and/or distribute electric power received at the electrical interface 108 into electric power used by any of the electric components of the hatchery 100. As a non-limiting example, the hatchery 100 can include one or more transformers configured to transform electric power received at and/or by the electrical interface 108 into, for example, three phase, 480 volt (V) electric current at 30 amps (A) (e.g., for a refrigerator or chiller providing temperature control of at least a portion of the shipping container 105), single phase 120 V at 100 A, and single phase 240 V at 100 A. In addition, electric components can be electrically connected to a distribution panel to receive a flow of electric power therefrom. Although not shown, the hatchery 100 can also include any number of electrical outlets, switches, relays, fuses, and/or any other suitable electric or electronic components allowing operation of any suitable portion of the hatchery 100. In this manner, the electric and/or electronic components of the hatchery 100 are electrically coupled to and/or receive electric power from the electrical interface 108.

As described above, the hatchery 100 includes the set of cultivation chambers 110, the water circulation system 115, the gas circulation system 120, and the light system 125. The cultivation chambers 110 can be any suitable shape, size, and/or configuration. For example, each hold tank 110 can be a tank or other enclosed structure having an open top (or portion configured to open) allowing access into an inner volume. In some embodiments, the cultivation chamber(s) 110 can be an aquarium or any number of aquaria. The cultivation chambers 110 are configured to receive a flow or volume of water and a flow or volume of air (and/or other liquids and/or gases) to create, form, and/or define an environment, habitat, ecosystem, and/or the like suitable for target product development and/or the development of biological components of a target product. In some implementations, the cultivation chambers 110 can also receive any suitable additive(s), nutrient(s), binder(s), etc. configured to facilitate the development of the target product and/or biological component of the target product disposed therein. In some implementations, the cultivation chambers 110 can create, form, and/or define a habitat suitable for hatching one or more species of macroalgae (or any of the biological components thereof) and/or the like. For example, the cultivation chambers 110 can be any suitable structure configured to contain aqueous media (e.g., water, air, nutrients, additives, binders, etc.) suitable for receiving and developing macroalgae sori, zoospores, gametophytes, and/or sporophytes.

Although not shown in FIG. 2, the hatchery 100 can include any suitable support structure on which the cultivation chambers 110 can be disposed such that the cultivation chambers 110 are raised off the floor of the container 105. In some implementations, such an arrangement can allow plumbing and/or drain lines to be run below each cultivation chamber. In some implementations, the cultivation chambers 110 can be formed of a clear acrylic material. In other implementations, the cultivation chambers 110 can be formed of any other suitable material. In some implementations, the set of cultivation chambers 110 can include one, two, three, four, five, six, seven, eight, nine, ten, or more cultivation chambers. For example, in some implementations, the set of cultivation chambers 110 includes five cultivation chambers.

The water circulation system 115 of the hatchery 100 can be any suitable configuration with any number of devices, pipes, fittings, inlets, outlets, filters, pumps, reservoirs, holding tanks, etc. In some embodiments, for example, the water circulation system 115 can include a holding tank configured to receive a flow of water from the water source 151 via the water interface 107. In some implementations, the water circulation system 115 can include one or more filters configured to filter water from the water interface 107 prior to delivery into the holding tank. The filter(s) can be and/or can include one or more pre-filters, ultraviolet light filters (UV filters), reverse osmosis filters (R/O filters), and/or any other suitable filter. In some implementations, the water circulation system 115 can also include a chiller or the like configured to chill or cool a flow of water received from the water interface 107 prior to delivery into the holding tank.

As described above, the water source 151 at the deployment site 150 can provide a flow of freshwater or saltwater, or a separate flow of each. The water circulation system 115 includes a holding tank that can receive a flow of filtered and/or chilled water. Where the water supply 151 provides only freshwater, naturally occurring elements can be mixed with the freshwater (either prior to delivery into the holding tank or mixed in the holding tank) to produce saltwater. The water circulation system 115 can include any suitable pump configured to provide a flow of saltwater from the holding tank to, for example, each of the cultivation chambers 110. Moreover, the water circulation system 110 can include any number of pipes, plumbing, valves, pumps, etc. configured to establish fluid communication between the holding tank and each cultivation chamber 110. The pipes and/or plumbing can include at least one outlet corresponding to each of the cultivation chambers. In addition, the hatchery 100 can include any suitable pipes, plumbing, valves, pumps, etc. configured to establish fluid communication with the water interface 107 and one or more portions of the hatchery 100 other than the cultivation chambers 110 such as sinks, hoses, fill stations, etc.

As described above, the terms “fluidically coupled” and/or “fluid communication” can refer to any suitable direct or indirect connection, coupling, and/or mode of conveyance that allows a flow of fluid between components so described. For example, the water circulation system 115 can include at least one outlet corresponding to each cultivation chamber 110 that allows a flow and/or volume of water to be transferred into the cultivation chambers 110. In some implementations, the outlets can be disposed outside the cultivation chambers 110 and directed toward an inner volume of the cultivation chambers 110 to allow water to be transferred through the water circulation system 115 into the cultivation chambers 110. Thus, in this context, while there is no physical coupling, the water circulation system 115 is fluidically coupled to the cultivation chambers 110 and/or is in fluid communication with the cultivation chambers 110.

In some implementations, the hatchery 100 can include, for example, freshwater plumbing and saltwater plumbing and can include one or more valves that can selectively fluidically couple the two plumbing systems if desirable. For example, freshwater received from the water interface 107 can flow through a freshwater portion of the water circulation system 115 and/or pipes or pluming thereof to a pump that can, for example, pump the freshwater to a water heater, a sink, a hose outlet, and/or any other component used in the hatchery 100. In some implementations, freshwater can then flow through a prefilter and an R/O filter and into the holding tank. In addition, a parallel flow of freshwater can be delivered to each of the cultivation chambers 110.

In some instances, saltwater received from the water interface 107 can flow through a saltwater portion of the water circulation system 115 and/or pipes or plumbing thereof to a pump that can, for example, pump the saltwater through at least a UV filter and into the holding tank. The saltwater can then be pumped from the holding tank to each cultivation chamber 110. In this manner, the water circulation system 115 can include, for example, two sets of pipes and/or plumbing, each of which includes at least one outlet corresponding to each cultivation chamber 110.

While the water circulation system 115 is described above as being fluidically coupled to and/or in fluid communication with the water interface 107, one or more components of the water circulation system 115 also can be electrically coupled to the electrical interface 108. For example, the water circulation system 115 can include any number of pumps, filters, valves, heaters, chillers, and/or the like that can receive a flow of electrical power from the electrical interface 108 to place the components in an “on” state and/or to transition the components between any number of operating states or modes (e.g., the transitioning of a solenoid to open, close, or switch a valve).

The gas circulation system 120 of the hatchery 100 can be any suitable configuration with any number of devices, pipes, fittings, inlets, outlets, pumps, reservoirs, compressors, etc. In some embodiments, for example, the gas circulation system 120 can include an air/gas pump, compressor, or the like that is electrically coupled to the electrical interface 108 (via a distribution panel, fuse block, and/or the like). The air/gas pump or compressor is fluidically coupled to any number of pipes or the like, which in turn, include at least one outlet configured to be in fluid communication with each of the cultivation chambers 110. For example, in some implementations, the gas circulation system 120 can include two outlets per cultivation chamber 110 with each outlet being disposed within the corresponding cultivation chamber 110. In some implementations, each outlet can be coupled to and/or terminate at an air stone or the like. Accordingly, the gas circulation system 120 can provide a flow of gas (e.g., air) to one or more of the cultivation chambers 110 to aerate a volume of water (e.g., saltwater) disposed therein.

Although not shown, the gas circulation system 120 can include any suitable filter configured to filter a flow of air into the air pump and/or a flow of air out of the air pump. In some implementations, for example, the gas circulation system 120 can include a high-efficient particulate air (HEPA) filter and/or any other suitable filter that can filter a flow of air from the air pump prior to the outlets corresponding to and/or disposed in the cultivation chambers 110.

While not shown in FIG. 2, the water circulation system 115 and the gas circulation system 120 can include any number of valves and/or the like configured to control a flow of water and gas, respectively, therethrough. For example, in some implementations, the gas circulation system 120 can include a valve at or just before each of the outlets associated with the cultivation chambers 110. Similarly, the water circulation system 115 can include a valve at or just before each of the outlets associated with the cultivation chambers 110. In addition, the water circulation system 115 can include one or more valves controlling and/or allowing a flow of water into the holding tank, into any number of sinks, fill stations, hoses, etc. Moreover, the water circulation system 115 can include drain system or line with one or more valves controlling and/or allowing draining of a fluid from the holding tank(s), sink(s), fill station(s), cultivation chamber(s) 110, and/or the like into the drain system or line and eventually out of the container 105. In some implementations, the valves of the water and gas circulation systems can be, for example, stopcock valves and/or other manually operated valves. In other implementations, the valves can be, for example, electric valves having a solenoid or the like configured to transition the valve between two or more operating states, modes, and/or flow paths. In some implementations, the hatchery 100 can include a central controller or the like that can provide any suitable interface for controlling the electric valves. In some implementations, the electric valves can be controlled via remote devices such as mobile devices, smartphones, tablets, laptops, desktops, and/or any other compute device(s). In addition, the hatchery 100 can include any number of sensors configured to sense any suitable characteristic associated with the water and/or gas disposed in and/or delivered to the cultivation chambers 110. In some instances, such an arrangement can allow for at least semi-autonomous control and/or operation of the hatchery 100.

The light system 125 of the hatchery 100 can be any suitable number and/or type of lights configured to provide light to and/or for each of the cultivation chambers 110. In some implementations, for example, the lights can be grow lights configured to provide light having a desired wavelength or range of wavelengths. In some instances, for example, the grow lights can be configured to emit full-spectrum light. In some instances, the grow lights can provide and/or emit light at or near the blue end of the visible light spectrum or the red end of the visible light spectrum. In some implementations, the grow lights can be transitioned between any number of states and/or configurations to provide and/or emit light having any desirable wavelength. In some instances, providing light at the blue or red ends of the visible light spectrum can, for example, selectively control the sex of gametophytes being hatched and/or developed in one or more of the cultivation chambers 110.

In some embodiments, the light system 125 can include a light (e.g., grow light and/or any other suitable type of light) corresponding to each cultivation chamber 110. In other embodiments, the light system 125 can include multiple lights per cultivation chamber 110 or can include a light that corresponds to and/or provides light for multiple cultivation chambers 110. In some implementations, the lights (e.g., grow lights) of the light system 125 can be suspended from the container 105 and disposed above the cultivation chambers 110. In some implementations, the lights of the light system 125 can be adjustable relative to the cultivation chambers 110 allowing the lights to be lowered closer to the cultivation chambers 110 or raised further from the cultivation chambers 110. In other implementations, the lights can be disposed and/or mounted in any suitable position relative to the cultivation chambers 110.

While the light system 125 is described above as including a number of grow lights or the like, in some implementations, the light system 125 can include any number of other lights configured to illuminate at least a portion of the interior of the container 105 or at least a portion of the hatchery 100. In addition, the light system 125 can include any number of switches, relays, and/or the like configured to control a flow of electric current to at least some of the lights to transition the lights between an “off” state and an “on” state. In some implementations, the switches and/or other control mechanism(s) of the light system 125 can be a manually operating switch. In other implementations, the switches and/or other control mechanism(s) can be “smart” switches or the like that can allow for manual control or remote control via a remote device such as a remote controller, mobile device, smartphone, tablet, laptop, desktop, and/or any other compute device(s).

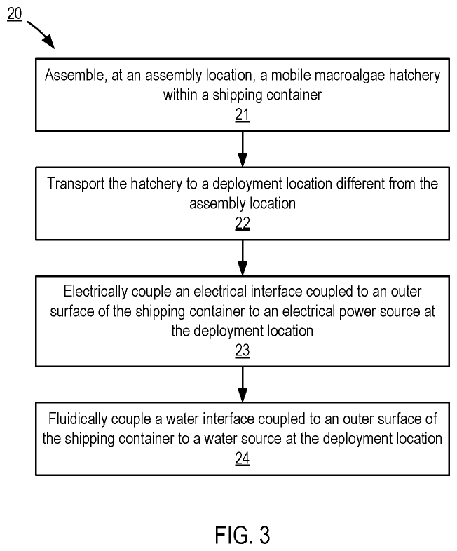

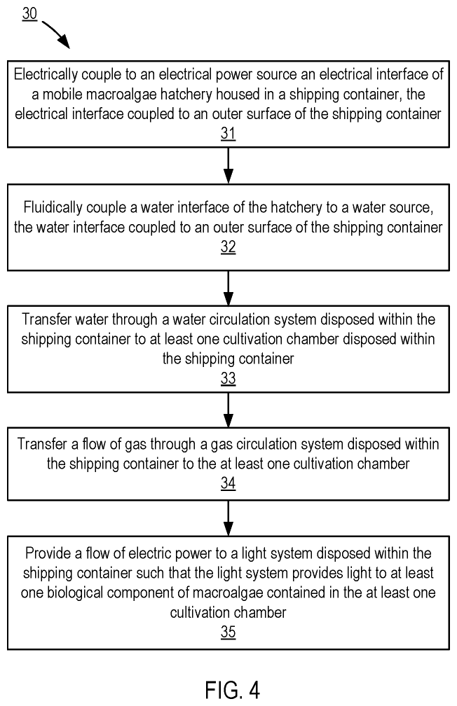

Methods of establishing, assembling, and/or using an offshore and/or mobile hatchery are described below with reference to FIGS. 3 and 4. For example, FIG. 3 is a flowchart illustrating a method 20 of establishing and/or using an offshore and/or mobile hatchery according to an embodiment. In some implementations, the method 20 includes assembling, at an assembly location, a mobile hatchery within a shipping container, at 21. The mobile hatchery can be similar to and/or substantially the same in at least form and/or function to the hatchery 100 and/or any other hatcheries described herein. For example, the hatchery can be a configured to facilitate the hatching, early development, seeding, affixing of biological material with a binder, and/or the like of one or more target products such as, for example, one or more species of macroalgae (or biological component(s) thereof).

In some instances, assembling the hatchery within the shipping container can provide a relatively efficient and scalable way of providing hatcheries to any desirable deployment site as needed. Assembling the hatchery can include installing and/or assembling in the shipping container at least a set of cultivation chambers (e.g., the cultivation chambers 110), a water circulation system (e.g., the water circulation system 115), a gas circulation system (e.g., the gas circulation system 120), and a light system (e.g., the light system 125). The shipping container can be a standard intermodal container, as described above with reference to the container 105. The hatchery can also include an electrical interface (e.g., the electrical interface 108) and a water interface (e.g., the water interface 107), each of which is coupled to an outer surface of the shipping container. The electrical interface is electrically coupled to one or more portions of the water circulation system, the gas circulation system, the light system, and any other suitable components included in the hatchery (or otherwise disposed in the shipping container). The water interface is fluidically coupled to one or more portions of the water circulation system and any other suitable components included in the hatchery (or otherwise disposed in the shipping container).

The mobile hatchery is transported to a deployment location different from the assembly location, at 22. For example, in some instances, the mobile hatchery can be assembled at any suitable location such as a land-based facility or the like. The assembling of the hatchery in the shipping container can be such that the container remains in compliance with established shipping requirements and/or standards allowing the shipping container (and the mobile hatchery contained therein) to be transported and/or shipped using known transportation modalities. For example, in some implementations, the hatchery can be transported via truck, train, ship, plane, and/or the like. In some instances, the deployment location can be any suitable site that can accommodate, for example, the container, as described above with reference to the deployment site 150. In some instances, the deployment location can be a relatively remote land-based location. In some instances, the deployment location can be an offshore platform or support structure (e.g., in an ocean or other body of water). In some instances, the deployment location can be a vessel such as a cargo ship or vessel (e.g., a transoceanic container ship) and/or any other suitable vessel. In some implementations, providing the mobile hatchery to the deployment location can allow for on-demand and/or on-location use, which can be more efficient, less expensive, and/or less likely to result in harm to the target products (e.g., macroalgae) than known processes of loading seeded cultivation apparatus onto a vessel for delivery to a deployment location in a body of water.

The electrical interface of the mobile hatchery is electrically coupled to an electrical power source at the deployment location, at 23. As described above, the electrical interface is coupled to the outer surface of the shipping container. The electrical power source can be any suitable electrical power source provided by, installed at or on, and/or otherwise operated at the deployment location. In some implementations, the electrical power source can be similar to and/or substantially the same as the electrical power source 152 described above with reference to FIG. 2. Moreover, with the electric and/or electronic components electrically coupled to the electrical interface, the electrical power source can supply a flow of electric power to the connected components of the hatchery via the electrical interface (and any distribution panel, fuse block, transformer, etc. electrically coupled therebetween).

The water interface of the mobile hatchery is fluidically coupled to a water source at the deployment location, at 24. As described above, the water interface is coupled to the outer surface of the shipping container. The water source can be any suitable water source provided by, installed at or on, and/or otherwise operated or available at or on the deployment location. In some implementations, the water source can be similar to and/or substantially the same as the water source 151 described above with reference to FIG. 2. In this manner, the water source can provide a flow of freshwater, a flow of saltwater, or separate flows of freshwater and saltwater. With the water interface fluidically coupled to the water circulation system and any other components of the hatchery (sinks, fill stations, hoses, etc.), the water source can supply a flow of water (e.g., freshwater and/or saltwater) to the connected components of the hatchery via the water interface (and any pump, manifold, plumbing, valving, etc. fluidically coupled therebetween).

FIG. 4 is a flowchart illustrating a method 30 of using an offshore and/or mobile hatchery according to an embodiment. The mobile hatchery can be similar to and/or substantially the same in at least form and/or function to the hatchery 100 and/or any other hatcheries described herein. For example, the hatchery can be a configured to facilitate the hatching, early development, seeding, affixing of biological material with a binder, and/or the like of one or more target products such as, for example, one or more species of macroalgae (or biological components thereof).

The hatchery can be disposed or assembled within a shipping container such as a standard intermodal container, as described above with reference to the container 105. The hatchery can include in the shipping container at least a set of cultivation chambers (e.g., the cultivation chambers 110), a water circulation system (e.g., the water circulation system 115), a gas circulation system (e.g., the gas circulation system 120), and a light system (e.g., the light system 125). The hatchery can also include an electrical interface (e.g., the electrical interface 108) and a water interface (e.g., the water interface 107), each of which is coupled to an outer surface of the shipping container. The electrical interface is electrically coupled to one or more portions of the water circulation system, the gas circulation system, the light system, and any other suitable components included in the hatchery (or otherwise disposed in the shipping container). The water interface is fluidically coupled to one or more portions of the water circulation system and any other suitable components included in the hatchery (or otherwise disposed in the shipping container). In some instances, the hatchery can be assembled in the shipping container at an assembly location, and once assembled, the shipping container can be transported to a deployment location, in accordance with the method 20 described above with reference to FIG. 3.

In some implementations, the method 30 includes electrically coupling the electrical interface of the mobile hatchery to an electrical power source, at 31. As described above, the electrical interface is coupled to the outer surface of the shipping container. The electrical power source can be any suitable electrical power source provided by, installed at or on, and/or otherwise operated at the deployment location. In some implementations, the electrical power source can be similar to and/or substantially the same as the electrical power source 152 described above with reference to FIG. 2. Moreover, with the electric and/or electronic components electrically coupled to the electrical interface, the electrical power source can supply a flow of electric power to the connected components of the hatchery via the electrical interface (and any distribution panel, fuse block, transformer, etc. electrically coupled therebetween).

The water interface of the mobile hatchery is fluidically coupled to a water source, at 32. As described above, the water interface is coupled to the outer surface of the shipping container. The water source can be any suitable water source provided by, installed at or on, and/or otherwise operated or available at or on the deployment location. In some implementations, the water source can be similar to and/or substantially the same as the water source 151 described above with reference to FIG. 2. In this manner, the water source can provide a flow of freshwater, a flow of saltwater, or separate flows of freshwater and saltwater. With the water interface fluidically coupled to the water circulation system and any other components of the hatchery (sinks, fill stations, hoses, etc.), the water source can supply a flow of water (e.g., freshwater and/or saltwater) to the connected components of the hatchery via the water interface (and any pump, manifold, plumbing, valving, etc. fluidically coupled therebetween).

Water is transferred through the water circulation system of the mobile hatchery to at least one cultivation chamber from the set of cultivation chambers, at 33. As described above, the water circulation system and each of the cultivation chambers is disposed within the shipping container. In some instances, the hatchery can include one or more pumps, valves, filters, and/or the like coupled to an outlet of the water interface and configured to receive a flow of water prior to delivering a flow of water to at least some of the components of the hatchery. For example, in some implementations, electric power can be provided to a pump, which in turn, can receive a flow of freshwater or saltwater from an outlet of the water interface and can deliver the flow of water to at least one filter. In some implementations, the filter can provide filtered water into a holding tank or directly into one or more of the cultivation chambers. In instances in which the water source provides a flow of freshwater, the method 30 can optionally include mixing naturally occurring elements with the freshwater (either prior to being delivered to the holding tank or mixing within the holding tank) to produce saltwater. As such, the water circulation system can then circulate and/or otherwise transfer saltwater from the holding tank to, for example, one or more of the cultivation chambers.

In some implementations, a portion of the freshwater can be provided (via any suitable pump(s), valve(s), and/or plumbing) to freshwater components of the hatchery such as sinks, fill stations, hoses, etc. without being mixed with the naturally occurring components to produce saltwater. For example, when the hatchery is used to hatch and/or seed macroalgae (or biological components thereof), a saltwater portion of the water circulation system can provide a flow or volume of saltwater (e.g., from the holding tank) into one or more cultivation chambers containing or receiving biological components of macroalgae (e.g., macroalgae sori, zoospores, gametophytes, and/or sporophytes), while a freshwater portion of the water circulation system can provide a flow or volume of freshwater to any suitable freshwater components of the hatchery.

Gas is transferred through a gas circulation system to at least one of the cultivation chambers, at 34. As described above, the gas circulation system is disposed within the shipping container. The gas circulation system can include, for example, an air/gas pump or the like that can deliver a flow of gas (e.g., air) through the gas circulation system in response to a flow of electric power. As described above with reference to the gas circulation system 120, the gas circulation system can include at least one outlet in fluid communication with each cultivation chamber. In some implementations, the gas circulation system can include two or more outlets disposed in each cultivation chamber. The outlets of the gas circulation system can, for example, be coupled to air stone(s) or the like. As such, the gas circulation system can provide a flow of gas (e.g., air) into the cultivation chambers, thereby aerating a volume of water contained therein.

In some implementations, with the water circulation system providing a flow and/or volume of water into the cultivation chambers and with the gas circulation system providing a flow of gas into the cultivation chambers to aerate the volume of water contained therein, the method 30 can optionally include disposing a target product in the cultivation chambers. In some instances, for example, the target product can be one or more species of macroalgae. In such instances, at least one biological component of macroalgae (e.g., macroalgae sori, zoospores, gametophytes, and/or sporophytes) can be disposed in the cultivation chambers. As such, the method 30 further includes providing a flow of electric power to the light system disposed within the shipping container such that the light system provides and/or emits light to or toward at least one biological component of macroalgae such as macroalgae sori, zoospores, gametophytes, or sporophytes contained in at least one of the cultivation chambers, at 35.

As described above with reference to the light system 125, the light system can include, for example, any number of grow lights configured to provide and/or shine light on or toward the cultivation chambers and the macroalgae (or biological components thereof) disposed therein. In some instances, the grow lights may be placed within the cultivation chambers. In some instances, the grow lights can be configured to provide full-spectrum light. In other instances, the grow lights can be configured to provide light having a desired wavelength or range of wavelengths. For example, in some instances, it may be desirable for the grow lights to provide light at or on the blue end of the visible light spectrum, light at or on the red end of the visible light spectrum, ultraviolet light, infrared light, etc., as described above with reference to the light system 125.

As described, the method 30 can be used to hatch and/or otherwise facilitate the early development of a target product or biological components thereof such as macroalgae sori, zoospores, gametophytes, and/or sporophytes. Although not shown in FIG. 4, once the target product or biological component of the target product has hatched and/or otherwise developed a desired amount, the method 30 can include and/or can allow for one or more seeding lines and/or substrates to be disposed in one or more cultivation chambers containing the target product. For example, the seeding lines and/or substrates can be and/or can be similar to, for example, the second member 14 of the cultivation apparatus 10 described above with reference to FIG. 1. In such instances, the seeding lines and/or substrates can bathe in the cultivation chamber(s) for any desired time allowing the target product (or biological components thereof) to be seeded on and/or otherwise attach to the seeding lines and/or substrates. In some instances, macroalgae (or biological components thereof) can be seeded, affixed, and/or attached to the seeding lines and/or substrates through direct-setting with macroalgae spores. In some instances, macroalgae (or biological components thereof) can be seeded, affixed, and/or attached to the seeding lines and/or substrates using a binder (e.g., a sticky binding material and/or the like) and then direct-setting with either macroalgae gametophytes, sporophytes, or macroalgae diploid cell cultures. In some instances, macroalgae (or biological components thereof) can be seeded, affixed, and/or attached to the seeding lines and/or substrates by fertilizing and growing the macroalgae in a tumble culture. In some instances, macroalgae (or biological components thereof) can be seeded, affixed, and/or attached to the seeding lines and/or substrates using any suitable method or any suitable combinations thereof. With the target product (or biological components thereof) seeded, affixed, and/or attached to the seeding lines and/or substrates (e.g., a second member of a cultivation apparatus), the seeding lines and/or substrates can be provided to a deployment vessel for assembly and deployment in a body of water (e.g., an ocean). Alternatively, when the deployment site of the hatchery is a vessel, the seeding lines and/or substrates can be assembled with one or more other components (e.g., a first member and/or an intermediate member) to form a cultivation apparatus, which then can be deployed in the body of water (e.g., ocean).

The method 20 and the method 30 described above with reference to FIGS. 3 and 4, respectively, can be implemented at any suitable deployment site such as, for example, a land-based deployment site, an offshore structure, and/or a vessel. In some instances, an offshore and/or mobile hatchery can be disposed in a shipping container and implemented and/or used, for example, on a ship, vessel, and/or the like. In some such implementations, the offshore and/or mobile hatchery can be a self-contained mobile hatchery such as the hatchery 100 described above with reference to FIG. 2. In other implementations, however, a vessel can include and/or at least a portion of the vessel can be adapted to form or function as an offshore hatchery that can be similar in at least function to the hatchery 100. As such, the vessel can allow hatching operations and/or methods to be performed while at sea (e.g., at and/or while traveling to a deployment location).

For example, such a vessel can include any number of reservoirs, holding tanks, baths, aquaria, cultivation chambers, etc., that can receive, for example, target product sori, zoospores, gametophytes, and/or sporophytes, one or more spools or reels of seeding line or other suitable seeding substrate, nutrient rich and/or filtered water (e.g., filtered seawater or the like), and/or the like. In some implementations, the seeding lines can be seeded and allowed to develop and/or grow to a desired extent and then attached to, for example, a first member or a second member of a cultivation apparatus. In other implementations, seeding lines can be attached to a first and/or a second member of any of the cultivation apparatus described herein, which can then be disposed in the tank, reservoir, chamber, etc. and the target product sori, zoospores, gametophytes, or sporophytes can attach, for example, to the seeding lines of the first and/or second members (e.g., the first member 12 and/or the second member 14 of the cultivation apparatus 10). In some implementations, the seeding lines can be and/or can form at least a portion of a second member of a cultivation apparatus (e.g., the second member 14 of the cultivation apparatus 10).

In some instances, the vessel can include multiple tanks or chambers and/or one or more multi-staged tanks or chambers allowing the seeding of the seeding line (or cultivation apparatus to which it is attached) to occur in stages. For example, in some instances, the seeding of the cultivation apparatus can include seeding a first member (e.g., similar to the first member 12) of the cultivation apparatus substantially without seeding a second member (e.g., similar to the second member 14) of the cultivation apparatus (or vice versa). After a desired time of seeding, the cultivation apparatus can be transferred to a separate tank or a separate stage of the same tank configured to allow seeding of the second member. In this manner, conditions within a tank or the like can be controlled and/or tailored, for example, based on the species of target product (e.g., macroalgae) being seeding. In some instances, the first member and the second member of the cultivation apparatus can be seeded in any suitable order or at the same time in same tank or in separate tanks.

In addition, the multiple tanks or chambers included in the vessel can be used to seed any number of seeding lines. For example, in some implementations, the vessel may include a sufficient number of tanks or the like to seed a desired number of cultivation apparatus for a given deployment location. In some instances, such an arrangement can allow for on-demand or near on-demand seeding of any number of cultivation apparatus. In some implementations, such an arrangement can allow for a reduction in the size of the tanks included in the vessel because the tanks do not need to hold an entire load of seeded cultivation apparatus that the tanks would otherwise hold if receiving the seeded cultivation apparatus from a traditional onshore hatchery facility.

The vessel also can include lighting systems and/or devices and/or the like configured to provide light with a wavelength at a desired frequency (e.g., a wavelength producing red light, blue light, white light, and/or any other suitable light including ultraviolet light and/or infrared light). As such, the seeded lines can be kept in the tanks, reservoirs, baths, cultivation chambers, etc. until the target product has grown a desired amount and then can be deployed, discharged, and/or otherwise transferred from the vessel to a desired deployment location at sea. In some implementations, the vessel can be such that the tanks or the like are allowed open to the open water (ocean, sea, etc.) and/or are flooded to allow the seeded cultivation apparatus to flow into the open water.

In some implementations, the vessel can include one or more reels, sleeves, racks, and/or other storage structures configured to store any number of cultivation apparatus prior to being seeded. Similarly, the vessel can include any suitable storage structure and/or the like configured to store seeding line prior to being seeded. In some instances, such an arrangement can increase an efficient use of space of the vessel relative to a vessel that receives seeded cultivation apparatus from an onshore hatchery. Moreover, in some implementations, such an arrangement can allow for on-demand or near on-demand assembly of pre-seeded and/or post-seeded cultivation apparatus. In some implementations, the vessel can include one or more machines, robots, mechanisms, devices, etc. configured to assemble the cultivation apparatus and/or configured to attach the seeding line to the cultivation apparatus.

In some instances, such a vessel can also be used, for example, to harvest mature target product (e.g., macroalgae). For example, in some implementations, the vessel can travel along a predefined path based at least in part on a known lifecycle of any number of macroalgae farms and/or deployment locations. In some instances, such a vessel can travel along a first portion of the predefined path during which the vessel is seeding and deploying seeded cultivation apparatus and after deploying a desired number of cultivation apparatus, can travel along a second portion of the predefined path during which the vessel harvests mature macroalgae. In other instances, the vessel can perform deployment and harvesting operations substantially simultaneously. In some implementations, any number of drones or the like can be deployed from the vessel to harvest mature macroalgae and/or to deploy seeded cultivation apparatus. In some instances, the vessel and/or the drones can be configured to harvest free floating macroalgae (e.g., wild macroalgae and/or macroalgae otherwise not attached to a portion of a cultivation apparatus or not included in a microfarm. Moreover, the vessel can include any suitable equipment, devices, mechanisms, laboratories, etc. allowing for assessment of macroalgae growth, weight and/or biomass calculations, carbon sequestration analyses and/or calculations, etc., and/or any other suitable analysis.

In some implementations, the vessel can include, perform, and/or can be configured to provide any and/or all of the following non-limiting advantages, features, processes, and/or the like.
Receiving spools and/or reels of seeding lines from land-based hatcheries and/or mobile hatcheries directly into storage tanks of the vessel.
Receiving pre-seeded seeding lines into empty tanks of the vessel and filling the tanks with, for example, filtered seawater onboard the vessel.
Onboard hatching of macroalgae, onboard seeding of any of the cultivation apparatus described herein, and deployment of seeded cultivation apparatus directly from the vessel.
Deployment of reels of cultivation apparatus (e.g., buoys)—including inflating and/or otherwise transitioning the cultivation apparatus from a storage state to a deployment state.
Towing target product deployments including any number of cultivation apparatus or the like from shore to a desired deployment location.
Storing cultivation apparatus in a storage or deflated state in a storage container or structure such as a rack (e.g., similar to a magazine rack).
Onboard inflation and/or transitioning of cultivation apparatus from a storage state to a deployment state and installation of any of the devices described herein such as timers and/or pressure-activated plugs, sensors, seals, communication devices, imaging devices, telemetry devices, tracking devices, etc.
Provide a machine, device, robot, and/or mechanism configured to connect seeded lines to cultivation apparatus (or configured to facilitate the connection of the seeded lines to the cultivation apparatus). In implementations in which the seeded lines form at least a portion of a second member, the machine, device, robot, and/or mechanism can be configured to couple at least temporarily the second member to a first member of the cultivation apparatus (e.g., via an intermediate member), as described above with reference to the cultivation apparatus 10.
Harvesting free floating macroalgae and/or farmed macroalgae using, for example, drones and/or any other suitable harvesting equipment (e.g., hooks, nets, winches, etc.).
Monitoring macroalgae farms and/or free floating macroalgae using drones, satellite links, sensors, scanners, cameras, radar, sonar, and/or any other suitable device.
Estimating weight and/or biomass of macroalgae using equipment and/or laboratories onboard the vessel (e.g., strain gauges, extensometers, cameras, scales, transducers, etc.) and allowing calculation of average weights over a given period of time to assess, etc., drag and negative buoyancy without having to relay data to onshore facilities and/or resources
Using shape of seeding lines, ropes, longlines, etc. to guide water and nutrients up the seeding line, etc.
Offshore fertilization of seeding line and/or seeded cultivation apparatus with nitrogen or iron to aid in growth.

While various embodiments have been particularly shown and described, it should be understood that they have been presented by way of example only, and not limitation. Various changes in form and/or detail may be made without departing from the spirit of the disclosure and/or without altering the function and/or advantages thereof unless expressly stated otherwise. Where schematics and/or embodiments described above indicate certain components arranged in certain orientations or positions, the arrangement of components may be modified.

Although various embodiments have been described as having particular features and/or combinations of components, other embodiments are possible having a combination of any features and/or components from any of embodiments described herein, except mutually exclusive combinations. The embodiments described herein can include various combinations and/or sub-combinations of the functions, components, and/or features of the different embodiments described.

The specific configurations of the various components can also be varied. For example, the size and specific shape of the various components can be different from the embodiments shown, while still providing the functions as described herein. More specifically, the size and shape of the various components can be specifically selected for a desired or intended usage. Thus, it should be understood that the size, shape, and/or arrangement of the embodiments and/or components thereof can be adapted for a given use unless the context explicitly states otherwise.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above.

What is claimed:

1. An apparatus, comprising:
a shipping container having disposed therein:
at least one cultivation chamber, each cultivation chamber configured to receive at least one biological component of a target product;
a water circulation system in fluid communication with each cultivation chamber, the water circulation system configured to provide a volume of water to each cultivation chamber;
a gas circulation system in fluid communication with each cultivation chamber, the gas circulation system configured to provide a flow of gas into each cultivation chamber; and
a light system configured to provide light to each cultivation chamber;
an electrical interface configured to electrically couple the shipping container to an electrical power source; and
a water interface configured to fluidically couple the shipping container to a water source.

2. The apparatus of claim 1, wherein the target product is macroalgae and the at least one biological component of the target product is at least one of macroalgae sori, zoospores, gametophytes, or sporophytes.

3. The apparatus of claim 2, wherein the light system includes at least one grow light configured to provide at least one of ultraviolet light, visible light, or infrared light to the at least one of the macroalgae sori, zoospores, gametophytes, or sporophytes contained in at least one cultivation chamber.

4. The apparatus of claim 1, wherein the shipping container further having disposed therein:
a temperature control system configured to regulate a temperature within the shipping container.

5. The apparatus of claim 1, wherein the shipping container further having disposed therein:
a drain system in fluid communication with each cultivation chamber, the drain system selectively allowing a flow of water from at least one of the cultivation chambers to a volume outside the shipping container.

6. The apparatus of claim 1, wherein the shipping container further having disposed therein:
a gas pump fluidically coupled to the gas circulation system, the gas circulation system configured to provide a flow of gas from the gas pump into each cultivation chamber.

7. The apparatus of claim 1, wherein the shipping container further having disposed therein:
a holding tank fluidically coupled to the water interface, the water circulation system being configured to transfer water between the holding tank and each cultivation chamber.

8. The apparatus of claim 7, wherein the water source is a saltwater source, the water circulation system being a saltwater circulation system configured to transfer saltwater from the holding tank into each cultivation chamber.

9. The apparatus of claim 7, wherein the water source is a freshwater source, the holding tank receiving a flow of freshwater from the freshwater source, the holding tank allowing one or more naturally occurring elements to mix with the freshwater contained in the holding tank to produce saltwater, the water circulation system being a saltwater circulation system configured to transfer saltwater from the holding tank into each cultivation chamber.

10. The apparatus of claim 9, further comprising:
a freshwater circulation system in fluid communication with each cultivation chamber, the freshwater circulation system configured to transfer freshwater into each cultivation chamber.

11. A method, comprising:
assembling, at an assembly location, a macroalgae hatchery within a shipping container;
transporting the macroalgae hatchery to a deployment location different from the assembly location;
electrically coupling an electrical interface of the macroalgae hatchery to an electrical power source at the deployment location, the electrical interface coupled to an outer surface of the shipping container; and
fluidically coupling a water interface of the macroalgae hatchery to a water source at the deployment location, the water interface coupled to an outer surface of the shipping container.

12. The method of claim 11, wherein the assembling includes:
thermally insulating at least a portion of an interior of the shipping container;
assembling at least one cultivation chamber within the shipping container, each cultivation chamber configured to receive at least one biological component of macroalgae;
assembling a water circulation system within the shipping container, the water circulation system having a holding tank in fluid communication with at least one water outlet corresponding to each cultivation chamber, the holding tank configured to receive a flow of water from the water interface, the water circulation system configured to transfer a volume of water from the holding tank into each cultivation chamber via the corresponding at least one water outlet;
assembling a gas circulation system within the shipping container, the gas circulation system having a gas pump in fluid communication with at least one gas outlet corresponding to each cultivation chamber, the gas circulation system configured to provide a flow of gas from the gas pump into each cultivation chamber via the corresponding at least one gas outlet;
assembling a light system within the shipping container, the light system configured to provide at least one of ultraviolet light, visible light, or infrared light to the at least one biological component of macroalgae contained in the at least one cultivation chamber in response to electric power from the electrical interface; and
a drain system in fluid communication with each cultivation chamber, the drain system selectively allowing a flow of water from at least one of the cultivation chambers to a volume outside the shipping container.

13. The method of claim 12, wherein the gas pump of the gas circulation system is electrically connected to the electrical interface, the gas pump configured to compress a volume of gas in response to a flow of electric power, the compressed gas configured to be transferred through the gas circulation system to at least one of the gas outlets; and
the water circulation system includes at least one water pump electrically connected to the electrical interface, the at least one water pump configured to provide a flow of water through the water circulation system from the holding tank to at least one of the water outlets in response to a flow of electric power.

14. The method of claim 12, wherein the transporting includes transporting via at least one of a marine cargo vessel or a train.

15. The method of claim 12, wherein the transporting includes transporting via a marine cargo vessel, the macroalgae hatchery being at the deployment location when on the marine cargo vessel and the marine cargo vessel is in a desired location on the open ocean.

16. The method of claim 12, wherein the biological component of the macroalgae is at least one of macroalgae sori, zoospores, gametophytes, or sporophytes.

17. A method, comprising:
electrically coupling an electrical interface of a macroalgae hatchery to an electrical power source, the macroalgae hatchery housed within a shipping container, the electrical interface coupled to an outer surface of the shipping container;
fluidically coupling a water interface of the macroalgae hatchery to a water source, the water interface being disposed outside the shipping container;
transferring water through a water circulation system of the macroalgae hatchery to at least one cultivation chamber, the water circulation system and the cultivation apparatus being disposed within the shipping container;
transferring gas through a gas circulation system to the at least one cultivation chamber, the gas circulation system being disposed within the shipping container; and
providing a flow of electric power to a light system disposed within the shipping container such that the light system provides light to at least one biological component of macroalgae contained in the at least one cultivation chamber.

18. The method of claim 17, wherein transferring the water through the water circulation system includes transferring a volume of water from a holding tank fluidically coupled to the water interface to the at least one cultivation chamber, the holding tank being disposed within the shipping container.

19. The method of claim 18, wherein the water source is a freshwater source, the method further comprising:
transferring a flow of freshwater from the water interface to the holding tank;
mixing the freshwater contained in the holding tank with one or more naturally occurring elements to produce saltwater, the transferring of the volume of water from the holding tank to the at least one cultivation chamber includes transferring a volume of saltwater from the holding tank to the at least one cultivation chamber.

20. The method of claim 19, wherein the water circulation system is a saltwater circulation system, the method further comprising:
transferring a flow of freshwater through a freshwater circulation system of the macroalgae hatchery to the at least one cultivation chamber, the freshwater circulation system being disposed within the shipping container and being at least partially independent of the saltwater circulation system.

21. The method of claim 17, wherein transferring the gas through the gas circulation system to the at least one cultivation chamber includes transferring a flow of air through the gas circulation system from a gas pump to the at least one cultivation chamber.

22. The method of claim 17, wherein the light system includes a plurality of grow lights, the providing electric power to the light system being such that the plurality of grow lights provide at least one of ultraviolet light, visible light, or infrared light to the at least one of the macroalgae sori, zoospores, gametophytes, or sporophytes contained in the at least one cultivation chamber.

23. The method of claim 17, wherein the biological component of the macroalgae is at least one of macroalgae sori, zoospores, gametophytes, or sporophytes.

24. The method of claim 23, further comprising:
disposing at least a portion of a cultivation apparatus in the at least one cultivation chamber to seed at least the portion of the cultivation apparatus with macroalgae gametophytes or sporophytes.

25. The method of claim 17, further comprising:
assembling the macroalgae hatchery housed within the shipping container at an assembly location; and
transporting the shipping container, after the assembling, to a deployment location different from the assembly location, the electrical power source and the water source being an electrical power source and a water source, respectively, at the deployment location.
